(19) United States
(12) Patent Application Publication
(10) Pub. No.: US 2026/0318462 A1
(43) Pub. Date: Oct. 15, 2026

(54) ROBOT FOR TRAVERSING CORRUGATED PIPES

(71) Applicant: Board of Trustees of Michigan State University, East Lansing, MI (US)

(72) Inventors: Xiaobo TAN, Okemos, MI (US); Christian Robert LUEDTKE, East Lansing, MI (US); Xinyu ZHOU, East Lansing, MI (US); Ehsan GHANE, East Lansing, MI (US)

(73) Assignee: Board of Trustees of Michigan State University, East Lansing, MI (US)

(21) Appl. No.: 19/466,639

(22) Filed: Feb. 2, 2026

Related U.S. Application Data
(60) Provisional application No. 63/753,492, filed on Feb. 4, 2025.

(51) Int. Cl. F16L 55/34; B25J 13/08; B25J 19/00; B25J 19/02; F16L 55/44; F16L 101/30

(52) U.S. Cl. CPC F16L 55/34; B25J 13/089; B25J 19/005; B25J 19/023; F16L 55/44; F16L 2101/30

(57) ABSTRACT

A robot for traversing corrugated pipes is provided. In another aspect, a robot includes sets of bendable fins or laterally elongated projections, each set outwardly extending from a node, between which longitudinally extends a biasing expansion body and a longitudinally elongated contraction tendon. In another aspect, the biasing expansion body includes a pliable and accordion-like bellows made from an elastomeric material, and the contraction tendon includes at least one, and more preferably two substantially parallel cables.

### CROSS-REFERENCE TO RELATED APPLICATION

The present application claims priority to provisional patent application Ser. No. 63/753,492. filed on Feb. 4, 2025, which is incorporated by reference herein.

### GOVERNMENT SUPPORT

This invention was made with government support under CNS 2125484 awarded by the National Science Foundation. The government has certain rights in the invention.

### BACKGROUND AND SUMMARY

The present disclosure generally pertains to a self-propelled robot and more particularly to a robot for traversing corrugated pipes.

Over 50 million acres of farmland in the United States use water drainage systems for the removal of excess surface and subsurface water, and control of excess water and various saline materials is necessary for improving the crop yields of agricultural land. These drainage systems consist of either perforated corrugated plastic pipes or clay/concrete tile running multiple feet below the surface in rows across the affected area, typically 4-inch diameter corrugated and flexible plastic pipes, which are known as tiling. However, the evaluation of failures in drainage networks is largely limited to the surface effects and pre-dug inspection wells. Even with these indicators, locating the issue generally requires digging additional inspection wells and either looking through the pipe between them or manually testing the flow between them by pouring water down the wells. All of this is complicated further by the fact that many farmers may not have accurate or easily accessible maps of their drainage networks.

Traditional robots have been designed to transverse the interior of a pipe network, such as those with smooth internal bores. These conventional designs range from wheeled and tracked rovers to multi-legged crawlers with numerous mechanisms for maintaining contact between the driving mechanism and the pipe wall. But the primary operational difficulties exploring the inside of these pipe networks imposes on robots are the tight space restrictions, the long lengths involved and the pipe corrugations themselves. The corrugations pose two potential problems for traditional robot designs. Firstly, a corrugated pipe wall reduces the contact area with the robot drive mechanism, which can lead to slippage inside the pipe when subject to fluid flow. The second potential difficulty is that the robot may become wedged between the corrugations of the pipe, which is especially problematic for screw-based locomotion or legged robot designs where the point of contact is relatively narrow.

One conventional robot employs pneumatically driven inchworm locomotion via various inflatable chambers. There are also conventional self-locking inchworm type robots, which are of three general types: those supporting leg locking mechanisms, those with inclined plane locking mechanisms, and those with cam locking mechanisms.

For supporting legs type robots, the legs are positioned such that when pulled in one direction, they tend to rotate away from the body of the robot, thereby resulting in increased normal forces. When these same legs are pulled in the opposing direction, the legs rotate towards the robot body, thereby decreasing the normal forces. A traditional sub-type of leg locking robots uses deformable bristles to fulfill the same role as the rotating legs. These bristles, when combined with a small vibrating or otherwise harmonic drive, can be used for micro-robots.

The conventional robots employing an inclined plane mechanism use a block on a sloped surface. When this block slides down the inclined plane, it reduces the normal forces. However, when it slides up the inclined plane, it increases the normal forces. Lastly, the traditional cam locking mechanism-style robot achieves the same difference of normal forces by replacing the rotating legs with rotating cams. For example, one such bi-directional robot connects two pairs of cams to a screw drive, which switches the pair of cams that are in contact with the wall.

In accordance with the present invention, a robot for traversing corrugated pipes is provided. In another aspect, a robot includes sets of bendable fins or laterally elongated projections, each set outwardly extending from a node, between which longitudinally extends a biasing expansion body and a longitudinally elongated contraction tendon. In another aspect, the biasing expansion body includes a pliable and accordion-like bellows made from an elastomeric material, and the contraction tendon includes at least one, and more preferably two substantially parallel cables. A further aspect employes an actuator, such as an electric motor, a solenoid or a shape memory alloy, to retract a tendon cable which operably shortens a longitudinal distance between spaced apart fin nodes, whereafter an expansion bellows urges and longitudinally pushes apart the fin nodes.

In an aspect, electric motor actuators located in a head node and a tail node of the robot, retract at least one, and more preferably two, cables to pull spaced apart fins sets toward each other and then release the cables so biasing bellows can push the fins sets away from each other. In another aspect, a first cable can be optionally retracted more than a second cable, to steer the robot when the robot reaches a branched pipe junction; this can be automatically performed by on-board microprocessor and software control, or remotely. A further aspect of the present robot includes actuators to move pipe-engaging fins between forward movement orientations and rearward movement orientations. A tether may be optionally connected to the robot in the event it needs to be manually pulled out of a pipe, if jammed in a fractured, displaced or clogged portion thereof.

Yet another aspect of the present robot includes oppositely and laterally projecting fins which are configured to be substantially rigid when engaging internal pipe corrugations to push the robot along within the pipe, and the fins are configured to be flexible when the fins move in an opposite direction passing over innermost peaks of the pipe corrugations. The flexibility of the fins acts in an anisotropic manner with the fins being the sole anchoring points to longitudinally move the robot. The fins may optionally be molded or 3D printed from a polymeric material, and may have gaps or opening areas to enhance flexure in a trailing edge thereof, in an exemplary embodiment. In one optional configuration, one or more sensors (such as a video camera) may be mounted to the robot, and in another additional or alternate configuration, a drill and drill-spinning actuator are mounted to an end of the robot to clear any clogs encountered within the pipe. A programmable controller, such as a microprocessor, battery and communications circuitry are mounted to and move with the robot inside the pipe, in an optional aspect thereof.

Still another aspect of the present robot employs a programmable controller and software instructions run therein, to automatically determine a location within a corrugated pipe and/or distance travelled therein, by counting contraction/expansion cycles between fin nodes. Alternately, the present robot employs a programmable controller and software instructions run therein, to automatically determine a location within a corrugated pipe and/or distance travelled therein, by counting ridges or corrugation peaks sensed by a video camera mounted to and traveling with the robot and employing corrugation image recognition software instructions. Another aspect automatically creates a map and location of an underground pipe network, such as branched pipes extending hundreds or thousands of feet, by using a programmable controller and software instructions run therein, to automatically track multiple positions of the robot as it moves within the pipe relative to above-ground and/or below-ground features, such as through use of a 3D magnetometer sensor and without GPS when the robot is moving underground. A method of moving a robot within a corrugated pipe is also provided.

### BRIEF DESCRIPTION OF THE DRAWINGS

FIG. 1 is a top elevational view showing a first embodiment robot and a corrugated pipe;

FIG. 2 is a perspective view showing the first embodiment robot;

FIG. 3 is a partially exploded, perspective view showing the first embodiment robot;

FIG. 4 is an enlarged perspective view showing a driving node of the first embodiment robot;

FIG. 5 is an enlarged perspective view showing an end node of the first embodiment robot;

FIG. 6 is a top elevational view showing fins employed in the driving node of the first embodiment robot, in different operating positions;

FIG. 7 is an enlarged top elevational view showing one of the fins of the first embodiment robot engaging the corrugated pipe;

FIG. 8 is an enlarged perspective view showing one of the fins of the first embodiment robot;

FIG. 9 is a series of top elevational views showing the first embodiment robot, in different operating positions within the corrugated pipe;

FIG. 10 is a top elevational view showing the first embodiment robot, in an idle condition;

FIG. 11 is a side elevational view showing the first embodiment robot, in the idle condition;

FIG. 12 is a top elevational view showing the first embodiment robot, in a forward movement condition;

FIG. 13 is a side elevational view showing the first embodiment robot, in the forward movement condition;

FIG. 14 is a top elevational view showing the first embodiment robot, in a backward movement condition;

FIG. 15 is a side elevational view showing the first embodiment robot, in the backward movement condition;

FIG. 16 is a graph of stroke versus velocity for the first embodiment robot;

FIG. 17 is a graph of frequency versus velocity for the first embodiment robot;

FIG. 18 is a perspective view showing an end node of a second embodiment robot;

FIGS. 19-22 are a series of top perspective views showing the end node of the second embodiment robot, in different operating positions;

FIG. 23 is a perspective view showing a third embodiment robot;

FIG. 24 is a perspective view showing a variation of an end node of the third embodiment robot;

FIG. 25 is a perspective view showing a fourth embodiment robot, in an expanded operating condition;

FIG. 26 is a side elevational view showing the fourth embodiment robot, in a contracted operating condition;

FIG. 27 is a perspective view showing a fifth embodiment robot;

FIG. 28 is a side elevational view showing the fifth embodiment robot;

FIG. 29 is a perspective view showing a sixth embodiment robot;

FIG. 30 is a perspective view showing the sixth embodiment robot;

FIG. 31 is a side elevational view showing the sixth embodiment robot;

FIG. 32 is a perspective view showing a seventh embodiment robot;

FIG. 33 is a perspective view showing the seventh embodiment robot;

FIG. 34 is a series of views showing an alternate fin arrangement for any of the robot embodiments, in different operating positions for different diameter corrugated pipes;

FIG. 35 is a series of views showing another alternate fin arrangement for any of the robot embodiments, in different operating positions for different diameter corrugated pipes;

FIG. 36 is a perspective view showing an alternate steering assembly for any of the robot embodiments; and

FIGS. 37 and 38 are software logic flow diagrams for any of the robot embodiments.

### DETAILED DESCRIPTION

The present self-propelled robot is configured for traversing corrugated pipes, such as perforated, polymeric and flexible tiling, which are widely employed in subsurface agricultural water drainage systems and highway road drainage systems. The robot adopts an inchworm-like peristaltic motion for its bellow-structured body, utilizing a self-locking mechanism, realized by exploiting an anisotropic interaction of its reconfigurable fins with the pipe ridges to achieve locomotion in the desired direction. A salient feature of the present design is that the robot robustly moves by an integer multiple of the ridge-to-ridge distance per actuation cycle, allowing the robot to self-localize within the pipe. It has a spring-like, bellow structure for achieving the desired compliance in cable-driven contraction and expansion, while its fins maximize their stiffness anisotropy in forward and backward directions when interacting with the pipe ridges. In operation, a rear locking mechanism holds the rear of the robot stationary while the body of the robot extends, moving the front along the line of motion. Subsequently, as the body retracts bringing the rear forward, the front locks in place and the rear unlocks.

The present robot locomotion mechanism is specifically tailored to corrugated pipes, such that it advances the robot by a designed distance for each actuation cycle, which provides a self-localization capability. Alternately, the pipe-contacting fin projections and/or compression/contraction locomotion mechanisms may also be used in a smooth bored pipe. Localization in GPS-denied underground pipes is a notoriously difficult problem, and being able to localize by the microprocessor controller automatically counting the number of actuation cycles, is a significant advantage of the present robot.

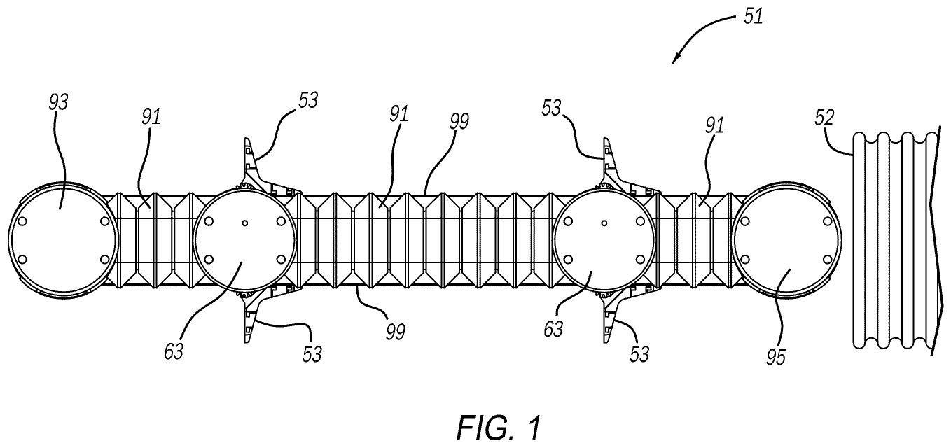

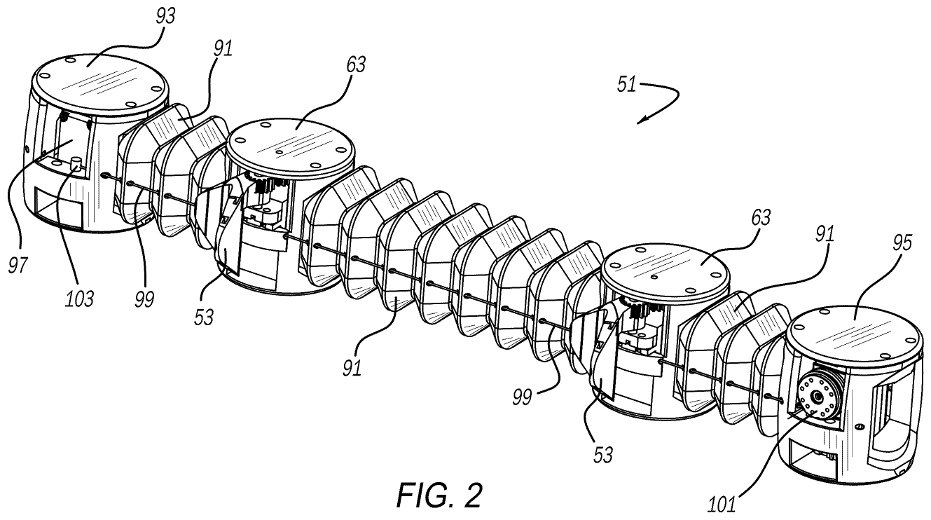

A first embodiment of the present robot 51 can be observed in FIGS. 1-15. Robot 51 is configured to longitudinally travel within one or more corrugated pipes 52, and includes sets of bendable fins 53, each having a pair of laterally elongated projections 55 joining at a central hub 57, the central hub including a pivot 59 and geared teeth 61. Pairs of fins 53 outwardly extend from opposite sides of a fin node 63 which contains an electromagnetic actuator, such as an electric motor 65 therein which operably rotates pinion gears 67 when energized. Pinions gears 67 are enmeshed with teeth 61 of fins 53.

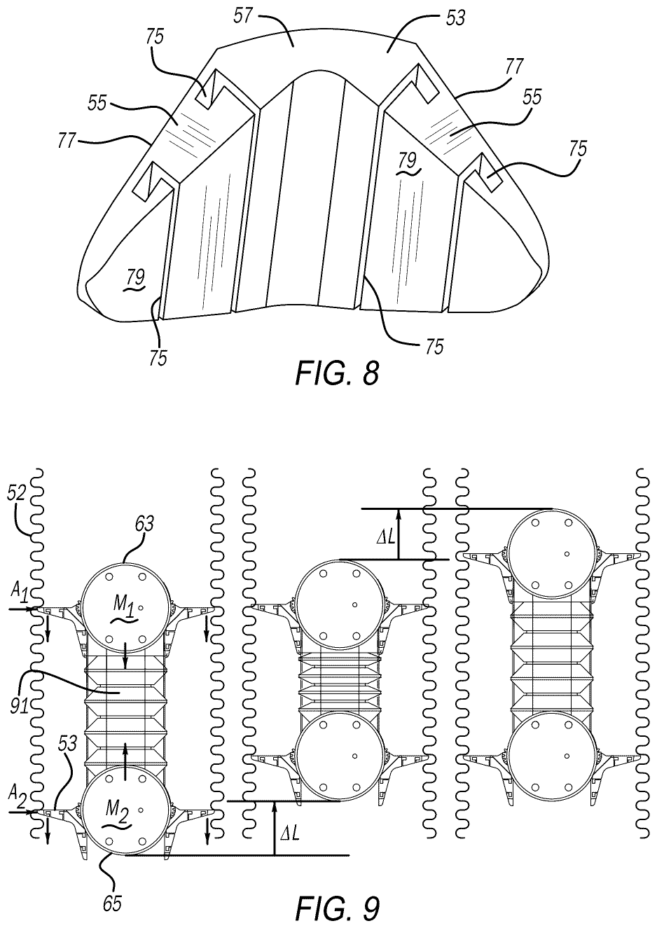

Projections 55 of each fin 53 have different flexure characteristics caused by multiple spaced apart slots 75, having elongated gaps in trailing edges thereof. This can best be observed in FIGS. 7 and 8. The present exemplary slots 75 each have an L-shaped configuration within a tapering outside shape for the fin, but other slot shapes may alternately be employed depending on the type, thickness and specific outside shapes of the fin. Each fin projection 55 is generally rigid in a trailing face 77 and a flexible opposite leading face 79. Each fin is preferably a thermoplastic polyurethane (“TPU”), elastic polymer, which may be manufactured by three-dimensional printing or injection molding, however, other elastomeric or flexible materials may be used.

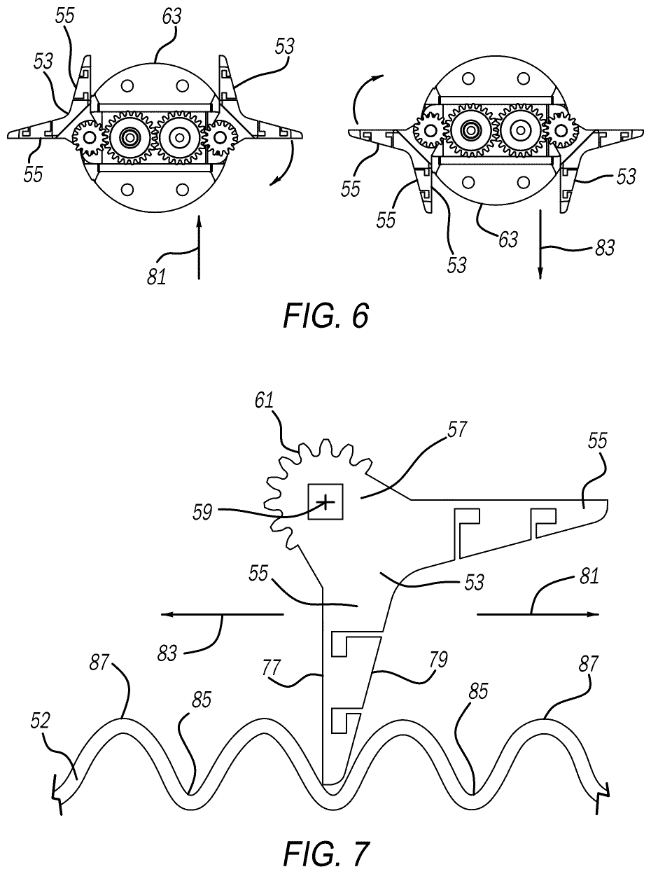

Electric motor 65 within each fin node 63 operably rotates the set of fins 53 coupled to that node between a robot-forward moving orientation or direction 81 (see the left illustration in FIG. 6) and a robot-backward moving orientation or direction 83 (see the right illustration in FIG. 6). As can be seen in FIG. 7, flipping from one projection 55 to the other projection 55 of fin 53, allows flexure of the projection which it is passing from one corrugation valley 85 to another, thereby flexing when interfering with a corrugation peak or ridge 87 between the valleys, yet allows rigidity and stiffness of the projection when it is maintaining its position within a corrugation valley as it pulls up the trailing node when longitudinal compression occurs within the robot. In other words, the laterally projecting fins are configured to be substantially rigid when engaging internal pipe corrugations to push the robot along within the pipe, and the fins are configured to be flexible when the fins move in an opposite direction passing over innermost peaks of the pipe corrugations. The flexibility of the fins acts in an anisotropic manner with the fins being the sole anchoring points to longitudinally move the robot.

Referring to FIGS. 1-3, robot 51 further includes one or more biasing bodies, preferably three pliable and accordion-like bellows 91 made from an elastomeric material. Each bellows is hollow and includes alternating flexible and pleated ridges and valleys, optionally with folding grooves at the valleys, to allow the bellows to longitudinally collapse when encountering a longitudinal compression force on their ends that is greater than its nominal, longitudinally biasing expansion force. The bellows are preferably made from an elastomeric material such as TPU. A middle bellows spans between and has its open ends compressing against fin nodes 63. A longitudinally shorter, leading bellows has its leading end compressing against a head node 93 and its trailing end contacting against the adjacent fin node 63. Similarly, an opposite and longitudinally shorter, trailing bellows has its leading end compressing against the adjacent fin node 63 and its trailing end contacting against a tail node 95.

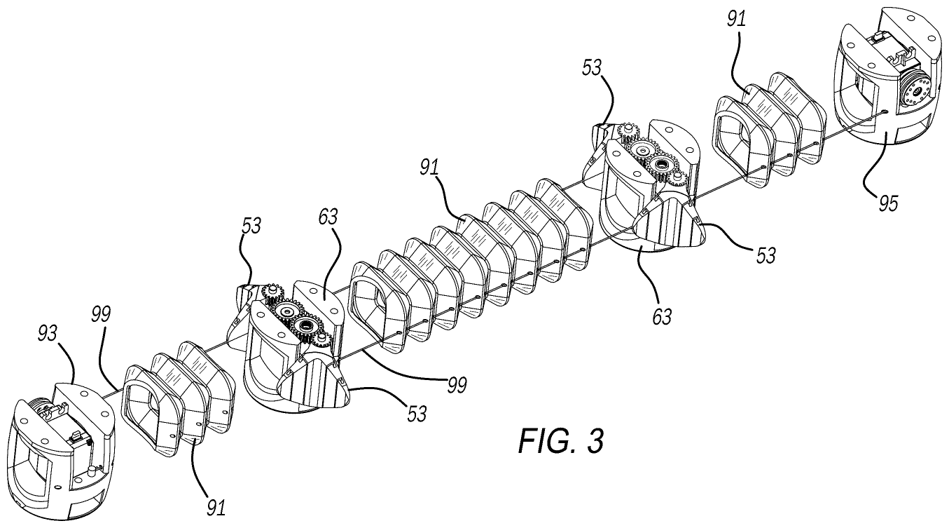

As can be observed in FIGS. 3 and 5, head and tail nodes, 93 and 95 respectively, each contain an electric motor actuator 97 for pulling a flexible tendon, such as a longitudinally elongated cable 99, by winding it about a spool 101 rotated by an output shaft of the motor. The head and tail nodes also include an internal anchor 103 which stationarily secures an opposite end of an opposite and generally parallel cable 99. The pair of cables 99 are preferably partially internal and partial external to the bellows, extending through apertures therein. Thus, the motor in the head node pulls (when the motor is energized) or releases (when the motor is deenergized) one cable while the motor in the tail node pulls or releases the opposite cable. Accordingly, pulling and retracting the cables serves to shorten a longitudinal distance between the spaced apart fin nodes, whereafter an expansion bellows urges and longitudinally pushes apart the fin nodes when the motors release the cables.

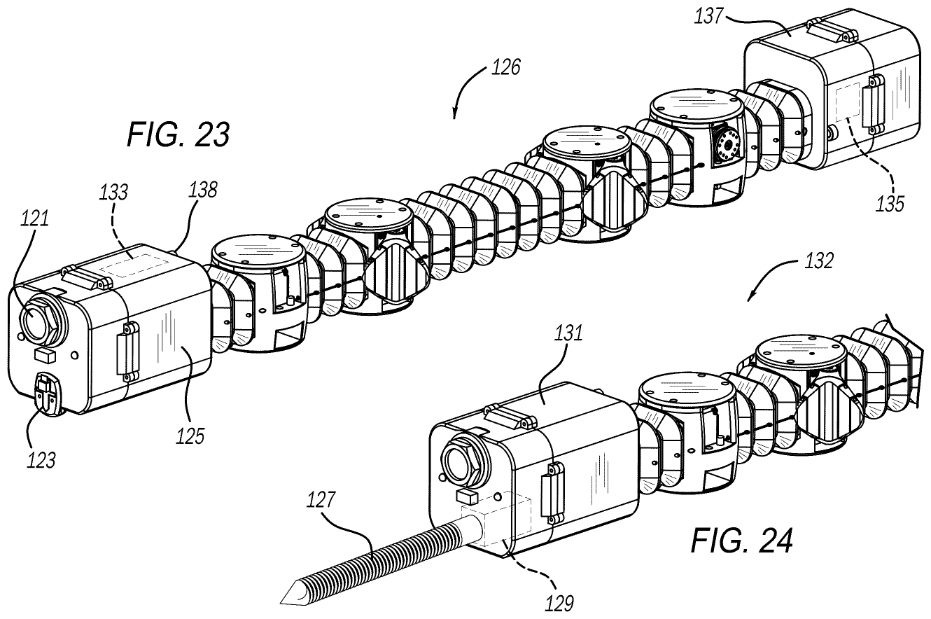

In an optional arrangement, a first cable can be retracted more than a second cable by the motors, to steer the robot when the robot reaches a branched pipe junction; this can be automatically performed by an on-board microprocessor and software control, or remotely. Alternately, a tether may be optionally connected to the trailing node of the robot in the event it needs to be manually pulled out of a pipe, if jammed in a fractured, displaced or clogged portion thereof. In one optional configuration, one or more sensors, such as a video camera 121 (see FIG. 23) and chemical sensor 123, may be mounted within a head node 125 of a robot 126 (which is otherwise the same as the FIG. 1-8 embodiment), and in another additional or alternate configuration, a drill 127 (see FIG. 24) and drill-spinning actuator 129 are mounted to an end node 131 of a robot 132 (which is otherwise the same as the FIG. 1-8 embodiment) to clear any clogs encountered within the pipe. A programmable controller, such as a microprocessor 133 (see FIG. 23), battery 135 and communications circuitry are mounted to and move with head node 125 and a tail node 137 of the robot inside the pipe, in an optional aspect thereof. An optional antenna 138 is connected to the communications circuitry and controller, to communicate with and send mapping and clog output signals and data to a remotely located computer or hand-held smartphone.

Optionally, the cameras can be used to examine the condition of the drainage pipe, such as automatically optically sensing obstructions or damage to the pipe. The head node can also be equipped with sensors such as a nitrate sensor to measure the chemical concentration in the water present in the pipe-such information can be used to guide the land management (e.g., application of fertilizers). Optionally, the camera may assist the controller in automatically identifying and localizing clogs. Underground drainage pipes can be clogged due to their perforated nature (which allows dirt or weeds to come in and develop into clogs, which negatively impact drainage performance). Accordingly, the present robot (with camera) can identify clogs and inform their locations, which enables informed excavation for pipe replacement. The present robot may optionally include a drilling tool to cut out the clogs.

The functionality of the first embodiment of the present robot will now be described with reference to FIGS. 6-15. The robot uses the paired fins to interact with the periodic ridges of the corrugated pipe, and the reconfigurable fins are designed to have anisotropic bending stiffness, enabling a bidirectional self-locking mechanism when the body expands and contracts. A compliant mid-section, consisting of the 3D-printed bellows, is compressed and extended through the pair of cables pulled by the servomotors. The two pairs of fins, one on the front and the other on the back, interact with the ridges of the pipe.

As shown in FIG. 7, the fins bend easily in the direction of intended locomotion, and thus can slide over the ridges when pushed in this direction under body contraction and extension, in which the fins are called disengaged; on the contrary, the bending stiffness in the opposite direction is so high that the fins deform little when they are pushed against the ridges in that direction, in which the fins are called engaged. As a result, FIG. 9 shows that when the body contracts (comparing the right and center illustrations), the front fins stay in their ridges while the rear fins slide, advancing the back part of the robot; thereafter, when the body extends (comparing the center and left illustrations), the front fins slide and the rear fins stay, advancing the front part of the robot and completing net movement of distance ΔL for the entire robot. In other words, when viewing FIG. 9 from right to left, the right image shows the bellows contracting to move top fins down, the central image depicts the bellows contracted with the top fins in their new position and the lower fins in their starting position, then the left image illustrates the bellows in an expanded condition which moves the lower fins further down the pipe.

Additionally, the fins are reconfigurable through the servomotors in the fin modules or nodes, which allows the reversal of the bending stiffness anisotropy and, thus, the moving direction of the robot. It is also noted that the exemplary mechanism results in “digital” displacement of the robot per actuation cycle; namely, the net advancement is always a multiple of the distance between neighboring ridges of the pipe and the multiple is uniquely determined by the stroke of the robot's body expansion/contraction. In addition, the two compliant side bellows are used to add some compliance between the fin module and the cable-pulling module, to facilitate the robot's robust locomotion in curved pipes.

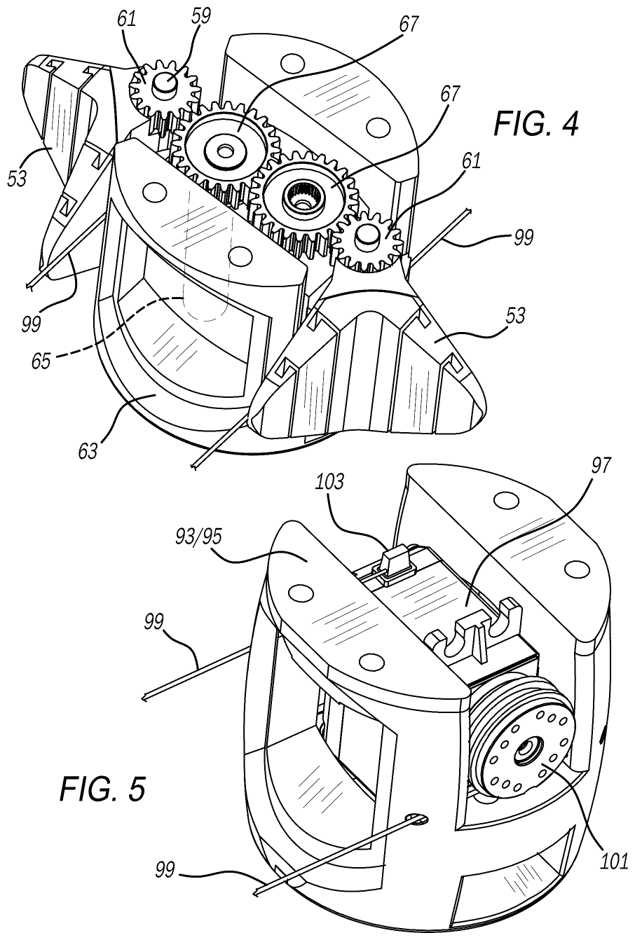

Referring to FIGS. 4-6 and 10-15, a mid-body section 141 is designed as a set of connected bellows 91 to act as a spring, which can repeatably contract and recover its original shape. The bellows include internal and external ridges or grooves which are thinner than the surrounding walls to encourage the bellows to flex and buckle at the desired areas while the majority of the strain also occurs at these areas.

The stiffness of the body bellows must be balanced between the torque needed to contract them and the allowable friction and drag forces. An exemplary and nonlimiting design of the mid-body bellows has a 3.4 mm wall thickness, 1.9 mm thinned ridges, a bellow height of 20 mm, a bellow depth of 20 mm, and a number of bellows equaling a total length of 60 mm such as three bellows.

As discussed hereinabove, head and tail cable-pulling modules or nodes 93 and 95 house servomotors for driving the cables. The nodes are designed as largely cylindrical structures with rounded bottoms to minimize the friction with the pipe corrugations. Each servomotor serves as a winch for one of the two cables, which run the length of the robot. In addition, the module serves as the anchor point for the other cable, allowing them to serve as a functional pair.

Also as discussed hereinabove, fin modules or nodes 63 are designed from a similar basic shape as the cable modules. A difference for the fin module, however, is that at the top of the cylinder, a system of interlocking gears connects to a gear mounted on the servomotor, allowing for control of the position of both fins in the pair with one servomotor.

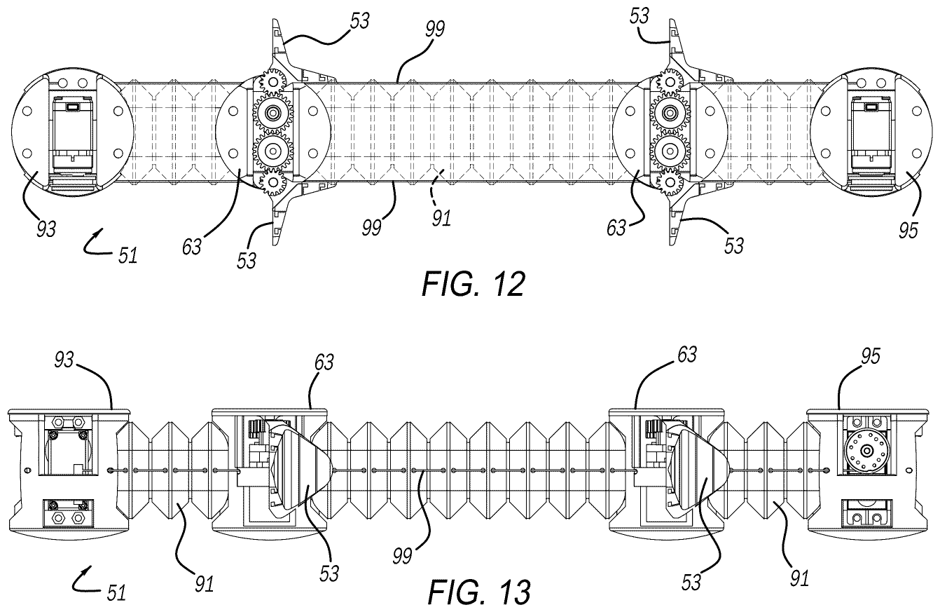

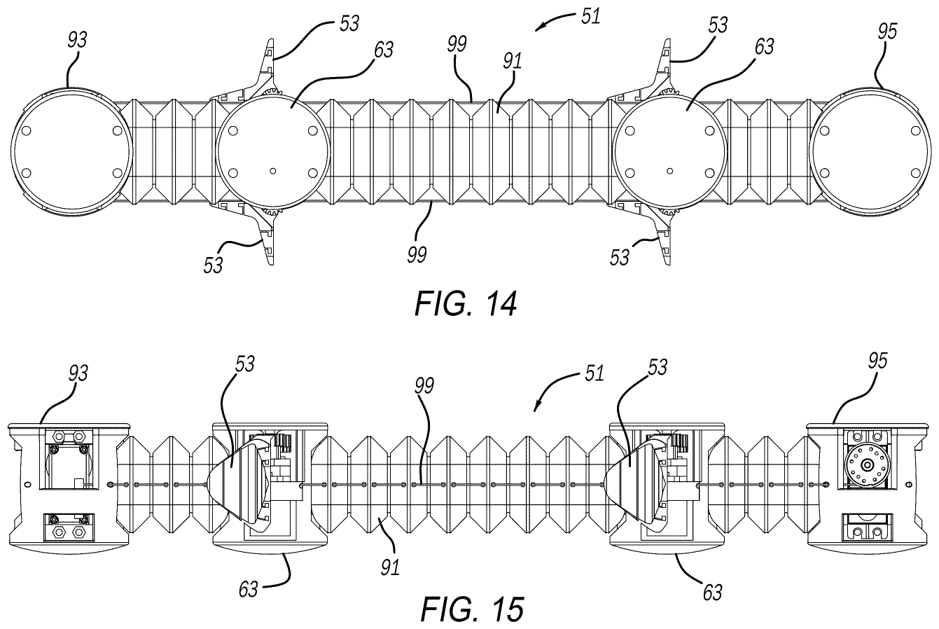

Each fin 53 includes two connected symmetric branches or projections 55 forming an L-shape. As shown in FIGS. 12 and 14, one branch is held flush with the robot body while the other extends out perpendicular to the body and interacts with the pipe ridges. The fins are designed to have reduced stiffness when being bent in the forward direction compared to being bent in the other direction. The forward direction is the direction in which the extending fin branch deforms outward away from the flush fin branch. To achieve the anisotropic stiffness, slits are designed into the fin branches. The servomotors can reconfigure the L-shaped fins by switching the fin branches extending out, to change the locomotion direction of the robot.

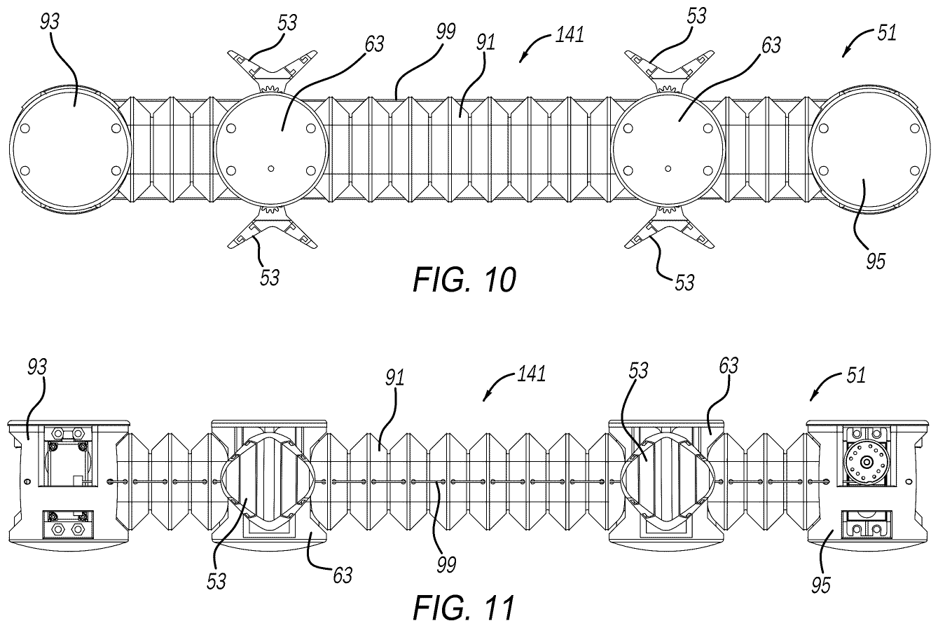

FIGS. 10 and 11 illustrate fins 53 moved to an idle orientation with both projections partially retracted yet partially extended. Next, FIGS. 12 and 13 represent fins 53 in a robot forward locomotion orientation (i.e., causing robot movement toward head node 93), with the trailing projections retracted against the robot body while the leading projections are laterally extended outboard. Moreover, FIGS. 14 and 15 represent fins 53 in a robot backward or rearward locomotion orientation (i.e., causing robot movement toward tail node 95), with the normally leading projections retracted against the robot body while the normally trailing projections are laterally extended outboard.

Wider slits reduce the stiffness in the reverse direction while the slit depth reduces the stiffness in the forward direction. In one exemplary base-line configuration, each fin has 1 mm slits with no cutout at the base, 6 mm slit separation and no angled slit depth change. Both the slit cutout width and slit separation are positively correlated to anisotropy up to 1 mm and 6 mm, respectively; after these values, the anisotropy plateaus at an approximate maximum. Thus, an optimized fin has a 2 mm slit cut out width, 8 mm slit separation and no angled depth change. Accordingly, a desired slit cutout width or gap has a range of 1-2 mm, and a range of slit separation or spacing is 6-8 mm.

The fins start to produce anchoring force and deform when increasing pulling force beyond the base resistive force. The engagement direction case illustrates a greater stiffness with a flatter displacement-force curve compared to the disengagement direction case. For the baseline fin design, the average stiffness values for the two directions are k_{disen}=0.9904 N/mm and k_{engage}=1.6417 N/mm, while for the optimized design, the average stiffness values for the two directions are k_{disen}=0.2020 N/mm and k_{engage}=1.6146 N/mm. For the baseline design, the ratio of the stiffness values in the two directions is γ_{b}=k_{engage}/k_{disen}=1.66, while that for the optimized design is γₒ=k_{engage}/k_{disen}=7.99. Additionally, for the baseline design, the maximum anchoring force in the disengagement direction is 14.1 N, while that for the optimized design is 4.8 N, which means that the optimized fins can slide over the pipe ridges in the intended direction more easily.

In a nonlimiting and exemplary prototype of the present robot, the frames of the cable-pulling modules and fin modules are 3D-printed from Siraya Tech ABS-like resin using a Peopoly Phenom Forge resin printer, while the compliant bellows and fins are 3D-printed from Overture TPU 95A using Prusa i3 MK3S+ filament 3D-printer. Exemplary servomotors for the cable-pulling modules are five-turn servomotors while the servomotors for the fin modules are 180-degree servomotors. Furthermore, exemplary cables are made from Trilene monofilament.

The two main factors that influence the velocity of the present worm-like robot are its operation frequency and its contraction stroke. An example of the present robot can operate at a frequency of 0-0.24 Hz while ensuring sufficient contraction stroke. The velocity of the robot is proportional to the frequency:

v=ΔL×f,

where f is the actuation frequency while ΔL is the net movement produced in each operating cycle. s denotes the contraction stroke, d denotes the distance between two neighboring ridges in the pipe, n denotes the number of ridges the fin passes in one operation cycle, and c denotes the extra clearance required for the fin to pass a ridge of the pipe. Thus, the stroke should be greater than nd+c to pass n ridges in a single cycle. Therefore,

$$Δ L = \{ \begin{matrix}0 , & if s < d + c , \\ ⌊ \frac{s - c}{d} ⌋ d , & if s \geq d + c .\end{matrix}$$

$$Accordingly :$$

$$v = \{ \begin{matrix}0 , & if s < d + c , \\ ⌊ \frac{s - c}{d} ⌋ df , & if s \geq d + c .\end{matrix}$$

In the present exemplary configuration, the distance between the neighboring ridges of the pipe is d=1.75 cm. The robot begins to advance in the pipe when the stroke reaches 5.16 cm, so c=3.41 cm is determined. The main body bellows and the two side bellows at the two ends, contract at the same time, while only the contraction of the main body bellows take effects on the movement of the robotic fins and the movement of the entire robot. Therefore, in the calculations herein, the contraction stroke that is used as independent variables only refers to the contraction stroke of the main body bellows instead of the stroke of entire robot's contraction. Also, the operation frequency can be controlled by tuning input voltage signal frequency of the cable-pulling servos.

In one experimental example, a section of corrugated pipe is 80 cm long with a diameter of 4 inches, is fixed horizontally on the ground in a straight line shape. The robot is initially placed on one end of the pipe and it is controlled to work in the forward gait or the backward gait in the corrugated pipe. The initial body length of the robot is 42.5 cm, so the distance the robot needs to pass is 37.5 cm. The time period taken to pass the distance is indicated by the first movement of the robot cable, and movement and falling of a flat plate placed at the end of the length of the corrugated pipe. The average velocity of the robot can be derived using the time period and passed distance.

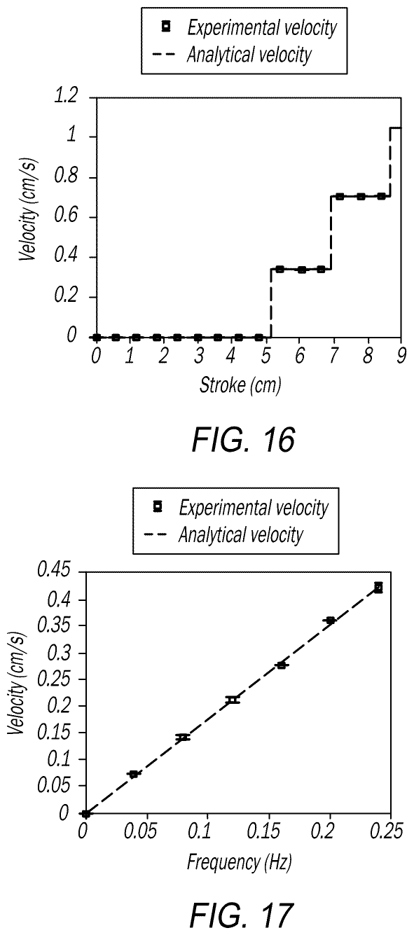

Two sets of experiments are conducted: the first set uses an operation frequency at 0.2 Hz and with a series of stroke values ranging from 0-8.5 cm, while a second set keeps the contraction stroke at 6 cm with a series of frequency values ranging from 0-0.24 Hz. The velocity of the robot was tested three times repeatedly for each setting. Expected experimental results are shown in FIGS. 16 and 17. For both experiments, the experimental data fits the analytical model within an error range of 3%. The well-predictable digital displacement behavior in each operating cycle and average velocity of the robot provides possibilities to automatically and accurately control its velocity and position with just open loop control.

Modelling of the present robot accounts for both the deformation of the anchoring fins and the potential for slippage under overload conditions. Represented as a hybrid system, the proposed model captures the movement dynamics of the robot, where the input is the actuated body length change. The model is used for the optimization of the input waveform for achieving the trade-off between travel speed and energy efficiency. It is also used for the optimization of fin characteristics. An increase in the anisotropy of the anchoring mechanism between the two directions is shown to improve the travel speed and energy efficiency simultaneously.

The robot is modeled as two mass blocks connected via the mid-bellows section, where each mass block has a pair of fins that interact with the corrugated pipe wall. The two mass blocks are denoted as M₁ and M₂, respectively. Let x₁(t) and x₂(t) represent the positions of the masses M₁ and M₂ at time t, respectively, while v₁(t) and v₂(t) denote their velocities. The origin of the x-axis is located at x₁(0). Additionally, let F₁, F₂, F_{c} represent the forces acting on M₁ and M₂ through the fins, and the traction force of the cable, respectively. The arrow directions for the three forces, as shown in FIG. 9, are defined as their positive direction.

The primary interaction force between the worm robot and its environment is the contact force between the fins and the ridges of the corrugated pipes, which introduces a nonlinear term in the dynamic model. In contrast, the effects of the environmental friction forces on the two masses M₁ and M₂ of fin nodes 63 are relatively small, and thus these forces are modeled as viscous friction forces. Additionally, the compliant body of the worm robot, specifically the middle bellows 91, can be modeled as a combination of a spring and a damper. Consequently, a dynamic model is derived for the two masses M₁ and M₂ based on Newton's law:

$$\begin{matrix}{\ddot{x}}_{1} = \frac{1}{{M}_{1}} [ {F}_{C} + k ( {x}_{2} - {x}_{1} - {L}_{0} ) + ( {\dot{x}}_{2} - {\dot{x}}_{1} ) - η {\dot{x}}_{1} - {F}_{1} ] , \\ {\ddot{x}}_{2} = \frac{1}{{M}_{2}} [ {F}_{C} + k ( {x}_{2} - {x}_{1} - {L}_{0} ) + ( {\dot{x}}_{2} - {\dot{x}}_{1} ) - η {\dot{x}}_{2} - {F}_{2} ] ,\end{matrix} \qquad ( 1 )$$

where k, L₀ and c are the average stiffness coefficient, the length at rest and damping coefficient of the robot body, respectively, while n is the viscous friction coefficients for the environmental viscous friction acting on the masses M₁ and M₂. Introducing velocities of the two mass blocks, v₁(t) and v₂(t), into the model, the dynamic model in a state space representation is derived:

$$\begin{matrix}{\dot{x}}_{1} = {v}_{1} , \\ {\dot{x}}_{2} = {v}_{2} ,\end{matrix} \qquad ( 2 )$$

$$\begin{matrix}{\dot{v}}_{1} = \frac{1}{{M}_{1}} [ {F}_{C} + k ( {x}_{2} - {x}_{1} - {L}_{0} ) + ( {v}_{2} - {v}_{1} ) - η {v}_{1} - {F}_{1} ] , \\ {\dot{v}}_{2} = \frac{1}{{M}_{2}} [ - {F}_{C} - k ( {x}_{2} - {x}_{1} - {L}_{0} ) + ( {v}_{2} - {v}_{1} ) - η {v}_{2} - {F}_{2} ] .\end{matrix}$$

It is worth noting that an appropriate method to model F₁ and F₂ is desired to establish a comprehensive dynamic model of the worm robot. Here, the anchoring positions of the anchoring mechanism are introduced, specifically the contact positions between each pair of fins 53 and corrugated pipe 52, denoted as A₁ and A₂, which is illustrated in FIG. 9. The interaction forces F₁ and F₂ are captured using the following formulation:

F₁=f(x₂−A₁).

F₂=f(x₁−A₁). (3)

Here, f(x) is a function determined by the design of the fin shape and structure, and the characteristics of the pipe 52, capturing how fins 53 interact with the corrugated pipe. To capture the anisotropic interaction, the model f(x) is constructed as a piecewise linear function with different slope values for x>0 and x<0, ensuring smooth continuity by incorporating an auxiliary hyperbolic tangent term:

$$f ( x ) = \frac{{k}_{disen} + {k}_{engage}}{2} x + \frac{{k}_{disen} - {k}_{engage}}{2} x tanh α x , \qquad ( 4 )$$

where k_{disen} and k_{engage} are the average stiffness values for the deformation of the fins when they are disengaged and engaged with the corrugated pipe, respectively. The parameter a is a scaling factor chosen to be large relative to the fin dimensions, ensuring that the hyperbolic tangent term primarily affects the transition near x=0.

As assumed, A₁ and A₂ are treated as two discrete system states that remain constant at the central position of the groove where the corresponding pair of fins is anchored into, until the states of the two masses, M₁ and M₂, satisfy specific switching conditions. The two discrete states A₁, A₂ and the four continuous states x₁, x₂, v₁, v₂ compose a hybrid system, whose dynamic model governing the continuous states is:

$$\dot{x} = {F}_{{A}_{1} , {A}_{2}} ( x , {F}_{c} ( t ) ) = [ \begin{matrix}{v}_{1} \\ {v}_{2} \\ \frac{1}{{M}_{1}} [ {F}_{c} + k ( {x}_{2} - {x}_{1} - {L}_{0} ) + \\ c ( {v}_{2} - {v}_{1} ) - η {v}_{1} - f ( {x}_{1} - {A}_{1} ) ] \\ \frac{1}{{M}_{2}} [ {F}_{c} + k ( {x}_{2} - {x}_{1} - {L}_{0} ) + \\ c ( {v}_{2} - {v}_{1} ) - η {v}_{2} - f ( {x}_{2} - {A}_{2} ) ] \\ -\end{matrix} ] , \qquad ( 5 )$$

where x=[x₁, x₂, v₁, v₂]^{T}, and the switching logic governing the discrete states is:

$$\{ \begin{matrix}{A}_{1} \to {A}_{1} + d , & if {x}_{1} > {A}_{1} + p , \\ {A}_{1} \to {A}_{1} - d , & if {x}_{1} < {A}_{1} - p , \\ {A}_{2} \to {A}_{2} + d , & if {x}_{2} > {A}_{2} + p , \\ {A}_{2} \to {A}_{2} - d , & if {x}_{2} < {A}_{2} - p ,\end{matrix} \qquad ( 6 )$$

where d represents the gap between adjacent ridges in the corrugated pipe, and p denotes the deformation required for the fins to switch anchoring to the next adjacent groove.

Additionally, for more practical robot control, the input of the dynamic system can be converted from cable force F_{c}(t) to the body length u(t). When the system input is the body length u(t), the following constraint is added to the dynamic model:

x₂(t)−x₁(t)=u(t). (7)

With the constraint, the continuous states used for describing the dynamic system can be reduced from four to two. The dynamic model governing the continuous states with u(t) as system input is:

$$\dot{y} = {G}_{{A}_{1} , {A}_{2}} ( x , 𝓊 ( t ) ) = [ \begin{matrix}{v}_{1} \\ \frac{1}{{M}_{1} + {M}_{2}} [ - 2 η {v}_{1} - f ( {x}_{1} - {A}_{1} ) - \\ f ( {x}_{1} + u - {A}_{2} ) - η \dot{𝓊} - {M}_{2} \ddot{𝓊} ]\end{matrix} ] , \qquad ( 8 )$$

where y=[x₁,v₁]^{T}. Thus, the switching logic governing the discrete states is:

$$\{ \begin{matrix}{A}_{1} \to {A}_{1} + d , & if {x}_{1} > {A}_{1} + p , \\ {A}_{1} \to {A}_{1} - d , & if {x}_{1} < {A}_{1} - p , \\ {A}_{2} \to {A}_{2} + d , & if {x}_{1} + 𝓊 > {A}_{2} + p , \\ {A}_{2} \to {A}_{2} - d , & if {x}_{1} + 𝓊 < {A}_{2} - p .\end{matrix} \qquad ( 9 )$$

Some relevant outputs of the dynamic system are:

x₂=x₁+u (10)

\dot{x}₂=\dot{x}₁+\dot{u} (11)

F_{c}=M₁\ddot{x}₁+k(L₀−u)−c\dot{u}+η\dot{x}₁+f(x₁−A₁) (12)

Open-loop simulations on the dynamic model are conducted to evaluate the effectiveness of the model. The parameters of dynamic model used in the simulation are shown as Table I.

TABLE I
PARAMETERS OF THE WORM ROBOT FOR SIMULATION

| parameter | symbol | value | |
|---|---|---|---|
| Mass of the first mass block | M₁ | 0.50 | kg |
| Mass of the second mass block | M₂ | 0.50 | kg |
| Stiffness coefficient of the bellow | k | 1000 | N/m |
| Damping coefficient of the bellow | c | 25 | N•s/m |
| Unstressed length of robot body | L₀ | 0.20 | m |
| Viscous friction coefficient for M₁ and M₂ | η | 25 | N•s/m |
| Deformation stiffness of fins when engaged | k_{engage} | 1600 | N/m |
| Deformation stiffness of fins when disengaged | k_{disen} | 200 | N/m |
| Auxiliary parameter in f (x) | α | 500 | |
| Gap between adjacent ridges on the pipe | d | 0.0175 | m |
| Deformation bound for switching | p | 0.035 | m |

To simulate cyclic peristalsis of the worm robot, the system input is chosen as the following form:

$$u ( t ) = \frac{s}{2} [ cos ( 2 π ft ) - 1 ] + {U}_{h} , \qquad ( 13 )$$

where s and f are the oscillating range and frequency of the body length change, and Un is the length of the body when it is expanded most. The oscillating range s represents the maximum contraction stroke of the worm robot's body during the peristaltic movement. The initial state of the robot is set as x₁(0)=0, v₁(0)=0, A₁(0)=0, and

$${A}_{2} ( 0 ) = ⌊ \frac{{U}_{h}}{d} ⌋ d .$$

The simulation results with s=0.10 m, Uₕ=0.175 m and f=1.0 Hz, show that the two mass blocks (i.e., fin nodes) of the worm robots perform continuous and natural wave-propagating forward locomotion. After several cycles, the system behavior stabilizes, demonstrating a consistent periodicity, with the robot covering a fixed distance in each cycle.

It is of practical interest to have faster travel speed while consuming less power for the robot, and these objectives are typically misaligned. The optimal combination of these two objectives is modelled as follows. The expression of long-term average velocity for the robot is:

$$v = {lim}_{n \to ∞} \frac{{x}_{1} ( t = nT ) - {x}_{1} ( t = 0 )}{nT} = {lim}_{n \to ∞} \frac{{x}_{1} ( t = nT )}{nT} , \qquad ( 14 )$$

where T=1/f is the period of the robot's peristaltic movements and n is the number of the cycles. The energy consumed by the present worm robot during a period of time can be computed from the positive mechanical power of the servo motors and integrated over the time period. The long-term average power can be expressed as:

$$\overline{P} = {lim}_{n \to ∞} \frac{{\int }_{0}^{nT} max ( - {F}_{c} \dot{u} , 0 ) dt}{nT} , \qquad ( 15 )$$

where F_{c} is the cable force of the worm robot and can be obtained from Eq. (12). To pursue a trade-off between the high average velocity and low average power consumption, a weighted objective function is given by:

J=ω₁v̅−ω₂P̅. (16)

where ω₁ and ω₂ are the weight of average velocity and average energy saving, respectively.

The sinusoidal peristaltic waveform, as the input signal for the system, is shown in Eq. (13). The gait optimization parameters are the stroke and the frequency of the input, θ=[s,f]^{T}. The body length when the robot is expanded most, Uₕ, is set at Uₕ=0.175 m, which is slightly smaller than the at-rest length of the robot body L₀ to make sure that the cable traction force F_{c}(t) is always positive, which serves as a practical constraint for the cable-driven method of body length control. The parameter constraints for optimization are sϵ[0, 0.15] and fϵ[0.1, 2] considering the practical robot size and the servo bandwidth. The simulation of the worm robot is based on the proposed dynamic model and the simulation time is set to Time=20T=20/f, i.e., n in Eqs. (14) (15) is set to 20. The optimizer used is a particle swarm optimizer, which is a versatile heuristic optimization method. By setting different ratios of

$$\frac{{ω}_{2}}{{ω}_{1} + {ω}_{2}} ,$$

Pareto optimal solutions can be obtained.

One can observe that the maximum average velocity is achieved when the maximum average power is consumed and the zero average velocity occurs for a zero power consumption. In the objective function Eq. (16), the negative weighted average power term −ω₂P̅ is a power penalty term relative to the velocity of the worm robot. Therefore, the higher the ratio of ω₂, the less average power and the less average velocity in the Pareto front. Additionally, the Pareto optimal solution corresponding to the maximum velocity and maximum power consumption is using the maximum stroke and frequency of the body length change within the constraints.

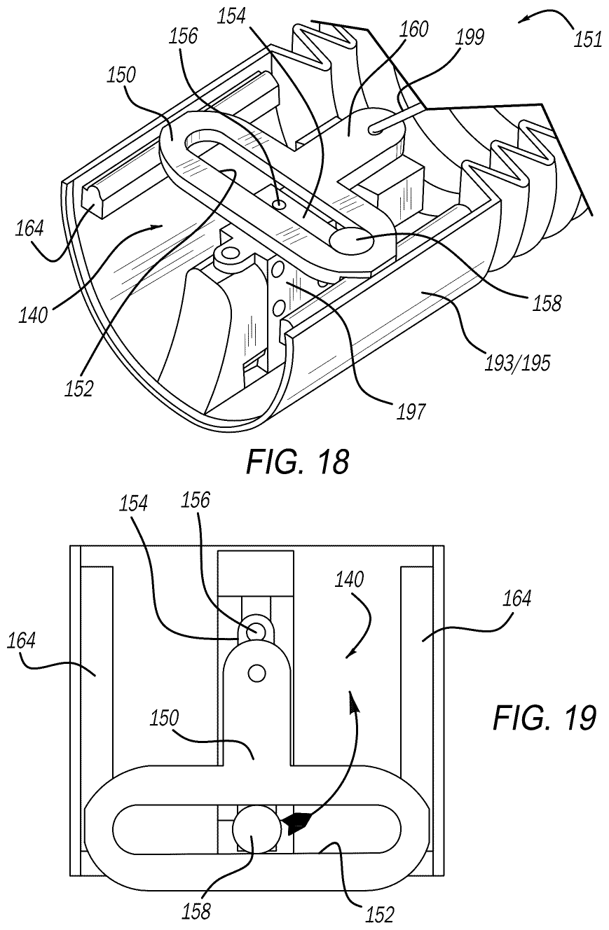

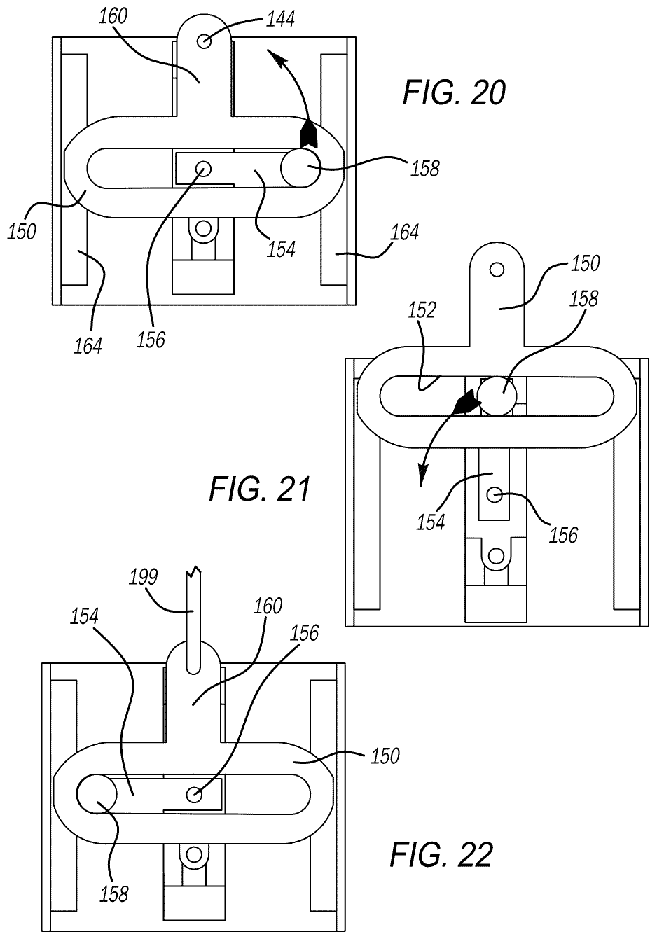

A second embodiment of the present robot 151 is illustrated in FIGS. 18-22. The present embodiment is similar to that of the first embodiment, except for the pulling and releasing mechanism for cables 199, which is herein designed for faster movement speed. DC motors 197, within head and tail modules or nodes 193 and 195, respectively, are used to increase the frequency of body contraction and expansion. A slider-crank style mechanism 140, of a Scotch-Yoke type, is attached to each cable-pulling DC motor 197.

The function of this design works as follows. The DC motor is attached to a disc or armature rotating it in a single direction at speed. The end of an armature/disc is attached to a sliding joint which allows the armature to move freely in the horizontal axis while translating the vertical axis motion to the attached cable anchor hole 144 or upstanding clasp. As the DC motor completes one rotation, the cable anchor hole is cyclically displaced in the vertical axis before returning to its initial starting position. Since the state of the system returns to the starting state at the end of one complete rotation, the DC motor has no need to change directions and can continue to rotate in the same direction for as long as the robot is powered. An example of one cycle of this mechanism can be seen by comparing the sequence of FIGS. 19-21. This approach beneficially removes the need to change the direction of the motor, removes any switching delay and allows for an easier implementation of higher frequency cycles.

More specifically, slider-crank mechanism 140 is used for driving the body compression and expansion between fin nodes 193 and 195. The mechanism includes a generally T-shaped yoke 150 with a laterally elongated lost motion slot 152 and a centrally extending tab 160. The electric motor rotates an elongated driving arm 154 about a pivot 156. A pin 158, extending from the arm, rides in a side-to-side manner within the slot as it is rotated in a circle by an underlying electric motor. The lateral outboard ends of the yoke are retained to linearly move by longitudinally elongated rails 164 on inner surfaces of the node or alternately, of a bellows body. The pin movement causes the tab of the yoke to advance and retract, which serves to longitudinally move cable 199 affixed to the hole in a distal end thereof. Alternately, the yoke may have two or more tabs if two or more cables are attached thereto.

In an alternate and optional design, a smart material sensor, such as TPU with an electrically conductive additive, such as carbon fibers or particles, is integrated into the fin structures. A piezoresistive sensor can directly monitor the deformation of the fins. These sensors can be used with any of the robot embodiments discussed herein.

After characterizing the response of the sensors to passing through the pipe, a detection algorithm in software instructions, run in a programmable controller, can be implemented which automatically counts the pipe ridges passed by the robot. This number of ridges can be used to locate the robot directly or converted by multiplying with the separation between ridges to standard length units such as meters. In one high-speed optional configuration, an encoder coupled to an electric motor can count how many compression and expansion cycles have been executed in order to determine the location of the robot relative to the pipe entrance, and/or to assist in automatically mapping the pipe network as the robot moves therethrough, and/or determining where an internal blockage is within the pipe network.

Alternately, it is optionally envisioned that electrically conductive particles, such as carbon, copper or other fibers or fillers, may be included in the TPU of the fins to sense fin-contact with a liquid inside the pipe, through electrical conductivity via an electrical circuit connected to one or more of the fins. Alternately, the conductive material of the fins may send a signal to the controller to allow the controller to automatically determine a characteristic of the liquid, such as indicative of its chemical composition.

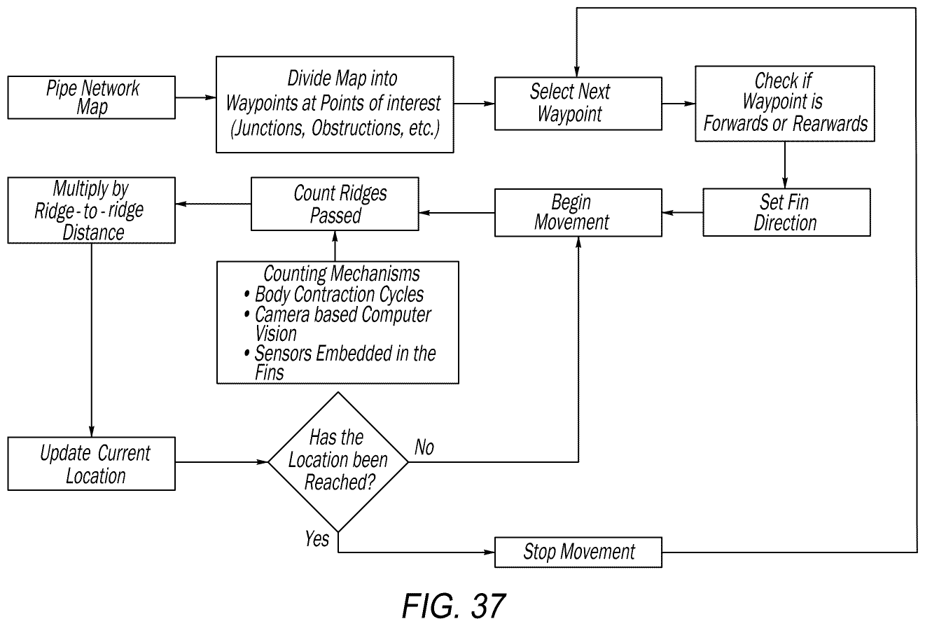

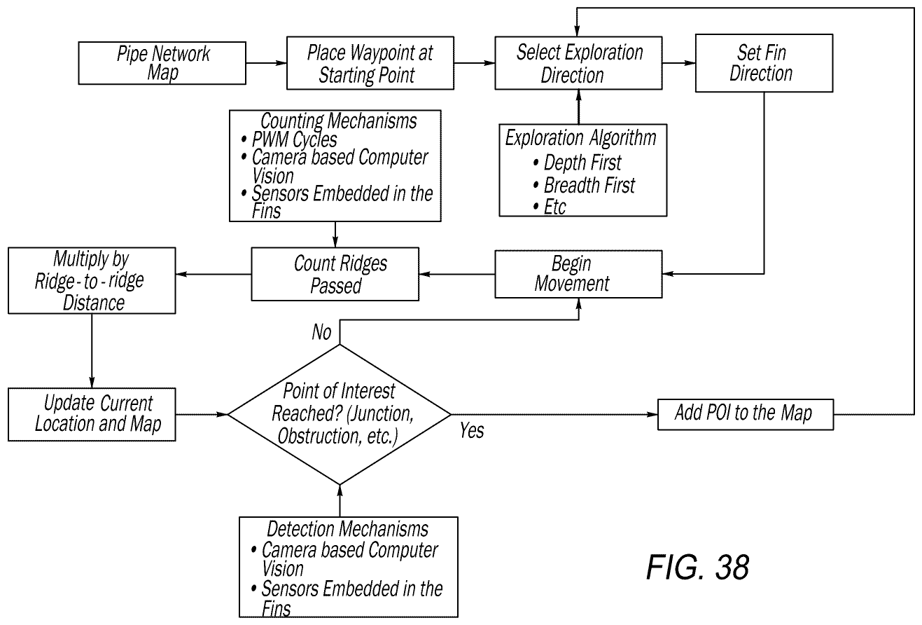

Still another aspect of the present robot employs a programmable controller and software instructions run therein, to automatically determine a location within a corrugated pipe and/or distance travelled therein, as is depicted in FIGS. 37 and 38, which are applicable to any of the robot embodiments herein. One approach employs software instructions counting contraction/expansion cycles between fin nodes. Alternately, the present robot employs a programmable controller and software instructions run therein, to automatically determine a location within a corrugated pipe and/or distance travelled therein, by counting ridges or corrugation peaks sensed by the video camera mounted to and traveling with the robot and employing corrugation image recognition software instructions.

Another aspect automatically creates a map and location of underground pipe network, such as branched pipes extending hundreds or thousands of feet, by using a programmable controller and software instructions run therein, to automatically track multiple positions of the robot as it moves within the pipe relative to above-ground and/or below-ground features, such as through use of a 3D magnetometer sensor and without GPS when the robot is moving underground.

The present controller and software instructions may optionally be employed with any of the embodiments herein for automatic mapping of underground drainage pipe networks. The robot can be equipped with a compass and an inertial measurement unit (“IMU”) to measure its 3D attitude when moving inside the pipe. In addition, due to its inherent localization capability, the robot knows how far it has travelled by any moment. The attitude information and the distance information can be combined to plot the trajectory of the robot underground, which is equivalent to the pipe arrangement information underground. A further aspect of the present robot includes an on-board programmable controller which is configured to automatically determine a location of the robot within a corrugated pipe by at least one of: (a) automatically detecting internal ridges of the corrugated pipe while the robot is moving therein; or (b) automatically detecting and counting contraction/expansion cycles of the robot while the robot is moving in the corrugated pipe. This allows the programmable controller to automatically create a map of an underground network of the corrugated pipes by moving the robot therethrough while automatically tracking positions of the robot, without the use of GPS.

Moreover, another feature of the present robot includes a first electric motor located within the first node operably moving the first set of fins when reverse direction movement of the robot is desired, a second electric motor located within the second node operably moving the second set of fins when the reverse direction movement of the robot is desired, at least a third electric motor pulling and releasing a tendon, such as the flexible cables, and the programmable controller being configured to automatically energize the electric motors to: compress and expand the first and the second nodes in order to longitudinally move the robot along the corrugated pipe; and to automatically advance and reverse longitudinal movement direction of the robot within the corrugated pipe.

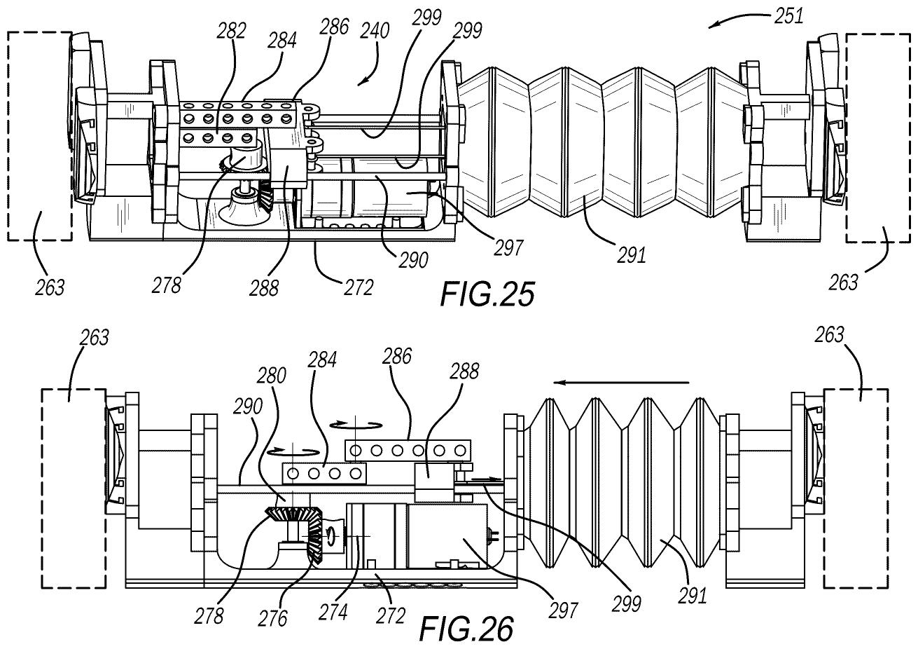

A fourth embodiment of the present robot 251 is shown in FIGS. 25 and 26. This configuration is similar to those above, with regard to the fins and fin nodes 263, bellows 291, and the controller with its software instructions. However, a different cable pulling and releasing mechanism 240 is employed. An electric motor 297 is located within an enclosed pulling module or node 272, which is between a fin node 263 and bellows 291. Motor 297 has a longitudinally oriented armature axis 274, about which an output shaft rotates an output gear 276. Gear 276 operably rotates an enmeshed driving gear 278, which is coupled to an upstanding driving shaft 280. Shaft 280, in turn, rotates an elongated first arm link 282, which is pivotally coupled to a second arm link 284. An end of second arm link 284 has a pivot pin 286, which causes a laterally elongated carriage 288 to longitudinally slide along stationary rails 290 in advancing and retracting directions. Cables 299 are coupled to protruding anchors on carriage 288, such that longitudinal movement of carriage 288 pulls and releases cables 299, which serves to compress and expand the robot body within bellows 291. The present exemplary mechanism 240 is a slider-crank construction using interconnected links and a unidirectional DC motor, which achieves shorter maximum stroke lengths than some other mechanisms but cycles faster than multi-directional motors. This embodiment provides more direct cable routing and achieves a more compact height and longitudinal length than some of the other designs herein.

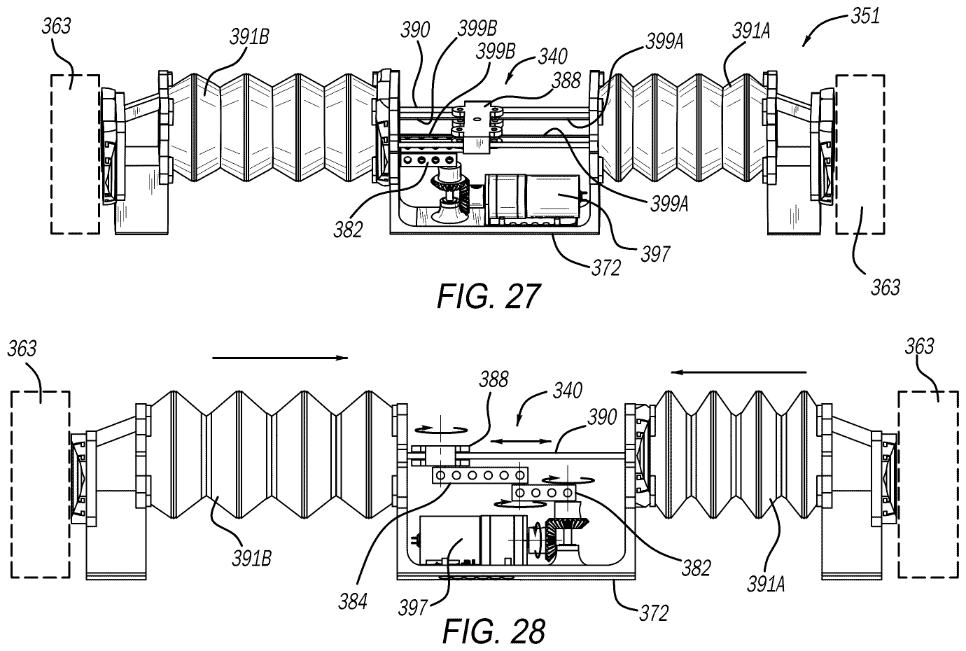

A fifth embodiment of the present robot 351 is shown in FIGS. 27 and 28. This configuration is similar to those above with regard to the fins and fin nodes 363, and the controller with its software instructions. The cable pulling and releasing mechanism 340, like that of the fourth embodiment, is also employed. For example, an electric motor 397 is located within an enclosed pulling module or node 372. Motor 397 causes unidirectional rotation of an elongated first arm link 382, which is pivotally coupled to a second arm link 384, which causes a laterally elongated carriage 388 to longitudinally slide along stationary rails 390 in advancing and retracting directions. However, a first set of cables 399A are coupled to one side of carriage 388 while a second set of cables 399B are coupled to an opposite side of the carriage. In the present embodiment, the arm links 382 and 384 are located below carriage 388, unlike the reverse packaging in the preceding embodiment.

Moreover, antagonistic first and second bellows 391A and 391B of robot 351 compress against opposite ends of cable pulling node 372. Thus, longitudinal movement of carriage 288 pulls and releases one set of cables 399A and 399B while causing the opposite force on the other set of cables, which serves to compress and expand the robot body within the bellows. In other words, when the first set of bellows is expanding, the second set of bellows are contracting, and vice versa. This embodiment advantageously reduces the torque needed by the cable pulling motor 374, as compared to some of the other designs herein. A third pair of fins, and an associated electric motor actuator and gear train (of the construction used for any of the other embodiments disclosed herein), is preferably mounted within the cable pulling node 372 for all of the antagonistic bellows embodiments set forth herein.

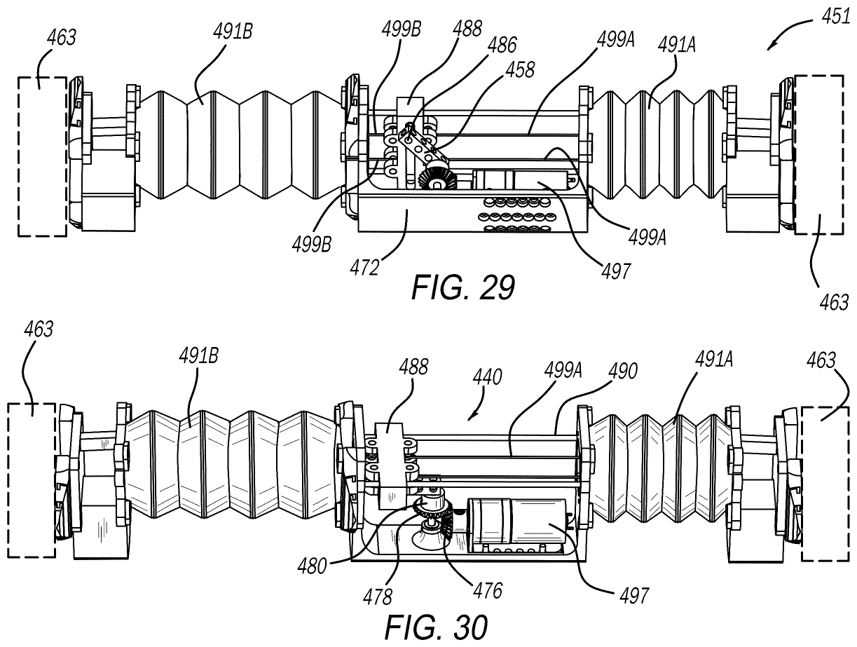

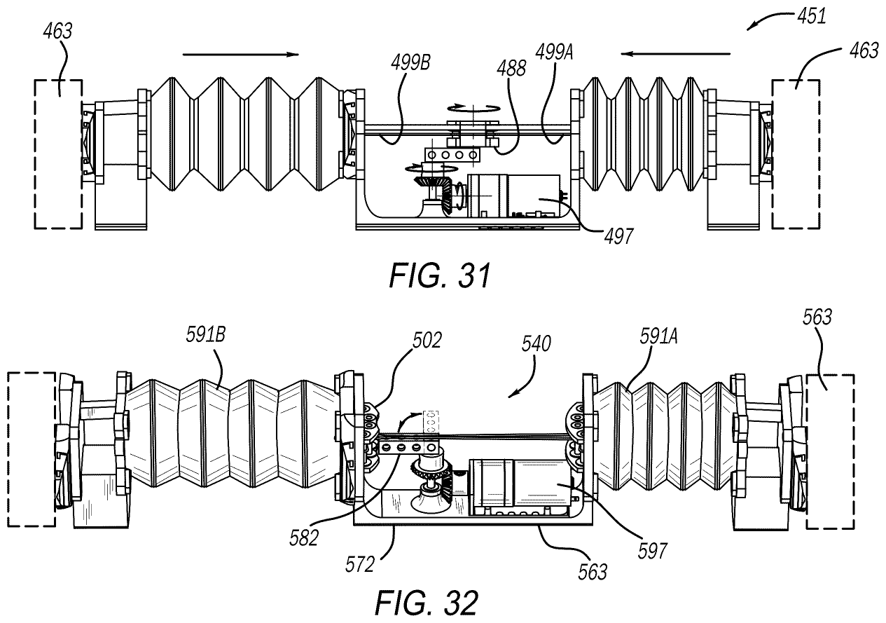

A sixth embodiment of the present robot 451 is shown in FIGS. 29-31. This configuration is similar to the fifth embodiment, with regard to the fins and fin nodes 463, bellows 491A and 491B, cables 499A and 499B, and the controller with its software instructions. However, a different cable pulling and releasing mechanism 440 is employed, which in the present situation is a scotch yoke arrangement. An electric motor 497 is located within an enclosed pulling module or node 472. Motor 497 rotates an output shaft, which rotates an output gear 476. Gear 476 operably rotates an enmeshed driving gear 478, which is coupled to an upstanding driving shaft 480, which further rotates a single elongated arm link 482. An end of arm link 284 has a pivot pin 458, which slides side to side in a lost motion slot 452 within a laterally elongated carriage 488. This causes carriage 488 to longitudinally slide along stationary rails 490 in advancing and retracting directions. Pairs of cables 499A and 499B are coupled to protruding anchors on opposite sides of carriage 488, such that longitudinal movement of carriage 488 pulls and releases the cables, which serves to compress and expand the robot body within antagonistic bellows 491A and B.

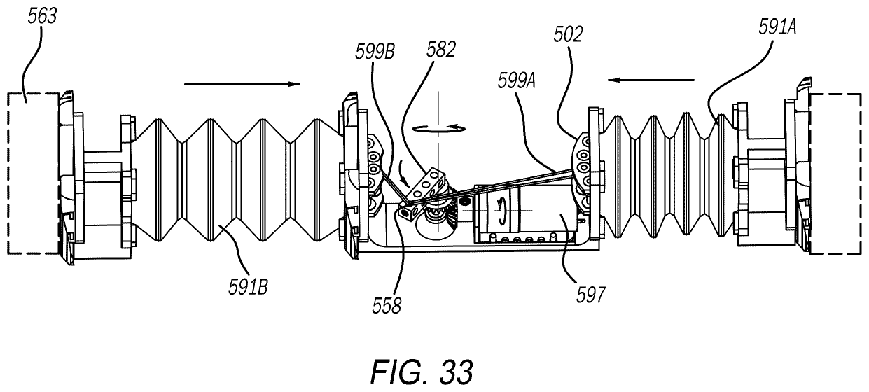

A seventh embodiment of the present robot 551 is shown in FIGS. 32 and 33. This configuration is similar to the sixth embodiment, with regard to the fins and fin nodes 563, bellows 591A and 591B, cables 599A and 599B, and the controller with its software instructions. However, a different cable pulling and releasing mechanism 540 is employed, that excludes a sliding carriage and rails. An electric motor 597 is located within an enclosed pulling module or node 572, which causes rotation of a single elongated arm link 582. An end of arm link 582 has one or more anchor pins 558, to which multiple pairs of elongated and flexible tendons, preferably four cables 599A and 599B. Unidirectional rotation of arm longitudinally pulls and releases all of the cables, simultaneously, which serves to compress and expand the robot body within antagonistic bellows 591A and B. Optionally, spaced apart posts 502 and bearings are stationarily mounted to leading and trailing portions of node 563 to space apart the cables. This configuration has less moving parts and less friction as compared to some other designs presented herein.

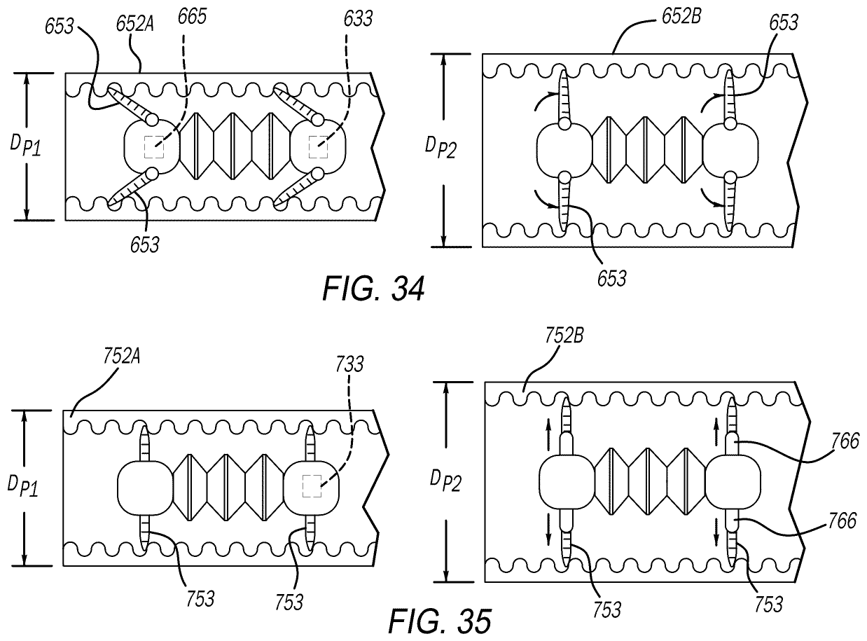

In the optional arrangement of FIG. 34, the present robot 651 is configured to adapt to different pipe diameters. The robot might need to go through variable passage space environments, such as changing pipe diameters as secondary corrugated pipes 652A branch off from a main pipe 652B, or to circumvent partial blockage within a pipe. In this exemplary design, an on-board programmable controller 633 and its software automatically control the angle of the flared fins 653, via energization of an electromagnetic actuator 665, such as a DC servomotor and its associated gear train to an intermediate position, or a solenoid. Referring to the right illustration, at 90 degrees from the body of the robot or a fully extended orientation (which may be less than 90 degrees), fins 653 are deployed to their maximum lateral length which can be reduced by decreasing the angle to an intermediate and offset angled position. Using the current reconfigurable fins 653, the minimum intermediate angle is 45 degrees (see the partially retracted fins 653 in the left illustration) at which point both sides of the fin are at the same length, whereby the tips of the fins contact against the corrugated ridges and/or valleys of pipe 652A, thereby locking the robot in place. A pressure sensor may be coupled to the fins and/or gear train, to detect that the robot has entered pipe 652A of reduced diameter Dₚ₁ versus the prior pipe 652B of larger diameter Dₚ₂, or vice versa, for subsequent adjustment control by the programmable controller, or optical sensing may be used by an on-board camera to send diameter output information to the controller for such an automated and real-time, diameter difference determination. For example, Dₚ₁ may be 4 inches and Dₚ₂ may be 6 inches. This same sensing, determination and control is used when an internal obstruction is encountered by the robot on one side of the pipe.

Another optional approach can be observed in FIG. 35. The present robot 751 is configured to adapt to different pipe diameters. In this exemplary design, an on-board programmable controller 733 and its software automatically control the lateral extension of fins 753, via energization of an electric motor actuator 765 and its associated gear train to move an extension linkage 766 or cam-driven arm from the retracted left illustration to the extended right illustration. Alternately, a pivot point of each fin may be moved along a generally laterally oriented camming slot by the electric motor, so as to laterally project further away from the associated fin node of the robot, when inside a larger diameter pipe. And the motor can then retract the opposite fins toward the node by moving the pivot point of each fin inboard when in a smaller diameter pipe or encountering an internal obstruction. Alternately, one fin projection may be longer than another such that the electric motor rotates between a laterally shorter projection or a laterally longer projection of an L-shaped fin. A pressure sensor may be coupled to the fins and/or gear train, to detect that the robot has entered pipe 752A of reduced diameter Dₚ₁ versus the prior pipe 752B of larger diameter Dₚ₂, or vice versa, for subsequent adjustment control by the programmable controller, or optical sensing may be used by an on-board camera to send diameter output information to the controller for such an automated and real-time, diameter difference determination. This same sensing, determination and control is used when an internal obstruction is encountered by the robot on one side of the pipe.

Another option is to alter the axis of rotation to that of the direction of motion. This allows the anisotropic structure to be lowered towards the bottom of the pipe making contact regardless of the diameter. This works under the assumption that the robot is lying on the bottom of the pipe and therefore there is a set maximum distance the structure needs to be lowered to reach the pipe wall. A method for maintaining this contact inside a fluid filled pipe would be necessary for robust operation, such as added weight, a ski/wheel on a spring-loaded arm at the top of the robot, or hydrodynamic foils along the robot's structure to create a downward force.

Steering of the robot can be achieved in various manners. While the current robot can follow curvy pipes, it would be useful for the robot to be able to actively and automatically control its turning, especially for scenarios involving branches of pipes for the robot to navigate. In a first configuration using the first embodiment's servomotor-driven cables, the dual servomotor-based winches not only contract and expand the fin nodes together, but they also contract and expand with a set cable length differential. Thus, one electric motor pulling its associated cable a different length and/or force than the other electric motor pulling its associated cable, steers and biases the robot down the desired path for a curved or offset angle for the pipe, or when there is an intersection of branching pipes.

In a second configuration for turning when the slider crank drive mechanisms are used, a pair of slider crank mechanisms may be employed, partial turns of the motors with appropriate angular differential mimic a limited contraction action along a desired curvature. Another approach for turning involves decoupling the fins inside a pair to allow for a skewed flaring of the fins. This differential in the fin flaring, and therefore the contact forces, biases the average motion of the robot towards one side of the pipe or the other.

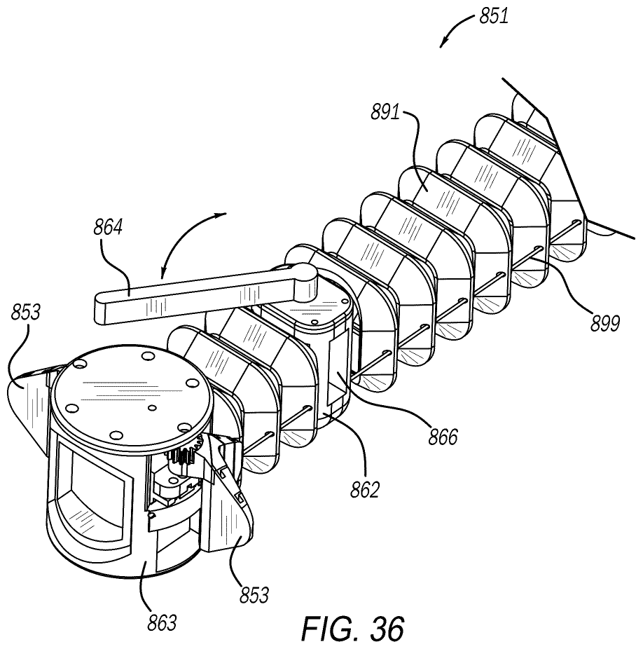

FIG. 36 illustrates a further steering construction for a robot 851 suitable for moving along an underground corrugated pipe network. The fins 853 and fin nodes 863, bellows 891, tendon cables 899, and controller and its software, are generally the same as any of the previously discussed embodiments, however, a steering node 862 is added. An elongated steering lever 864 is selectively rotated by an electric motor actuator 866 located within node 862, which is preferably mounted near a trailing end of the robot. When the camera and controller determine that a sharp turn is desired, the controller will automatically energize the motor 866 to cause the lever 864 to push against an inside wall of the corrugated pipe. This steering lever and control logic may alternately be used with a pipe having a smooth internal bore. Any of the steering configurations mentioned herein may be used with any of the robot embodiments.

Methods of using any of the robot constructions described herein within a corrugated pipe, are also provided. For example, this includes compression and expansion of the robot to longitudinally move it within a pipe, by pulling and releasing tendon cables, and/or via biasing bellows. Methods of using any of the automated programmable controller and software instructions, are further envisioned.

While various embodiments have been disclosed, it should be appreciated that other variations may be employed. For example, different fin shapes, node shapes, gear types, quantities and positioning may be employed, although certain advantages may not be obtained. Moreover, the preferred bellows may be replaced by one or more compression or other springs, but certain benefits may not be realized, such as the protection against in-pipe debris with the present enclosed bellows. In another example, different electronic components, actuators and electrical circuits can be used, although some of the present features may not be obtained. Any of the features of one embodiment may be used with any of the features of another of the embodiments, in any combination. While various embodiments of the present apparatus have been disclosed, modifications thereof are not to be regarded as a departure from the spirit or the scope of the present invention.

The invention claimed is:

1. A robot comprising:
a first node;
a second node longitudinally spaced apart from the first node;
a biasing body spanning between the nodes;
a first set of fins outwardly and oppositely projecting from the first node;
a second set of fins outwardly and oppositely projecting from the second node;
at least one longitudinally extending tendon being configured to contract the nodes toward each other; and
each of the fins being configured to flex when the associated node is longitudinally moving, and each of the fins being configured to be substantially rigid when the associated node is not longitudinally moving.

2. The robot of claim 1, further comprising:
an electromagnetic actuator configured to pull the at least one tendon to contract the nodes toward each other;
the biasing body longitudinally pushing the nodes away from each other; and
the tendon being an elongated and flexible cable at least partially extending within the biasing body.

3. The robot of claim 2, wherein the electromagnetic actuator is an electric motor and the biasing body is an accordion-like bellows, having alternating ridges and valleys, made from an elastomeric polymer.

4. The robot of claim 1, wherein each of the fins includes at least one slit in an edge away from a longitudinal movement direction of the robot, which allows the fin to flex when a top of the fin passes over an internal ridge of a corrugated pipe.

5. The robot of claim 1, further comprising:
at least one of the fins including multiple offset angled projections coupled to a central hub, the central hub including a pivot and geared teeth, the projections having different flexure characteristic; and
an electromagnetic actuator being configured to rotate the at least one of the fins between a robot-forward moving orientation and a robot-backward moving orientation, in order to contact an interior of a corrugated pipe with a different one of the projections depending on whether forward or backward movement of the robot is desired.

6. The robot of claim 1, further comprising:
the at least one tendon including multiple flexible cables;
a first electromagnetic actuator configured to pull a first of the cables to contract the nodes toward each other;
a second electromagnetic actuator configured to pull a second of the cables a different amount than the first of the cables to steer the robot within a corrugated pipe; and
the biasing body longitudinally pushing the nodes away from each other when the electromagnetic actuators release at least one of the cables.

7. The robot of claim 1, further comprising:
a slider-crank including a substantially T-shaped yoke with a laterally elongated lost motion slot and an extending tab, the tab being coupled to the at least one tendon;
an electric motor configured to rotate an elongated driving arm about a pivot; and
a pin, extending from the driving arm, being configured to ride in a side-to-side manner within the slot as it is rotated by the electric motor.

8. The robot of claim 1, further comprising:
a slider-crank including a laterally elongated slot within a sliding block, the block being coupled to the at least one tendon;
an electric motor configured to rotate at least one elongated driving arm about a pivot, an end of the driving arm being coupled to the slot of the sliding block; and
longitudinal movement of the sliding block pulling the tendon.

9. The robot of claim 1, further comprising:
at least one elongated driving arm coupled to the at least one tendon;
an electric motor configured to rotate the at least one elongated driving arm about a pivot; and
movement of the at least one driving arm pulling the tendon.

10. The robot of claim 1, further comprising:
an elongated steering arm;
an electric motor configured to rotate the steering arm; and
movement of the steering arm being configured to contact a distal end of the steering arm against internal corrugations of a corrugated pipe in order to assist in changing the longitudinal movement direction of the robot when the robot encounters a branched pipe intersection or a blockage within the corrugated pipe.

11. The robot of claim 1, further comprising electromechanical actuators located in the nodes reorienting the fins to account for different internal diameters of corrugated pipes to which tips of the fins contact during movement of the robot therethrough.

12. The robot of claim 1, further comprising a programmable controller detecting internal ridges of a corrugated pipe while the robot is moving therein, and the controller automatically determining a location of the robot within the corrugated pipe.

13. The robot of claim 1, further comprising a programmable controller detecting and counting contraction/expansion cycles of the robot while the robot is moving in a corrugated pipe, and the controller automatically determining a location of the robot within the corrugated pipe.

14. The robot of claim 1, further comprising a programmable controller automatically creating a map of an underground corrugated pipe network by moving the robot therethrough while automatically tracking positions of the robot, without the use of GPS.

15. The robot of claim 1, further comprising:
a head and a tail located at opposite longitudinal ends, with the nodes located between the head and the tail;
a camera mounted on the head;
a battery mounted within the tail;
a programmable controller located within the head or the tail;
a first electric motor located within the first node operably moving the first set of fins;
a second electric motor located within the second node operably moving the second set of fins; and
at least a third electric motor pulling and releasing the tendon.

16. A robot comprising:
a first fin node;
a second fin node longitudinally spaced apart from the first fin node;
biasing bellows spanning between the fin nodes and being configured to longitudinally push the nodes away from each other;
a first set of fins outwardly and oppositely projecting from the first fin node;
a second set of fins outwardly and oppositely projecting from the second fin node;
longitudinally extending and flexible cables being configured to contract the fin nodes toward each other;
a head node and a tail node located at opposite longitudinal ends, with the first and second fin nodes located between the head node and the tail node;
a camera mounted on the head node;
a first electric motor located within the first fin node operably moving the first set of fins when reverse direction movement of the robot is desired;
a second electric motor located within the second fin node operably moving the second set of fins when the reverse direction movement of the robot is desired;
at least a third electric motor pulling and releasing the cables; and
a programmable controller located within the head node or the tail node configured to automatically determine a position of the robot within a corrugated pipe, to automatically energize the electric motors to compress and expand the fin nodes in order to longitudinally move the robot along the corrugated pipe, and to automatically advance and reverse longitudinal movement direction of the robot within the corrugated pipe.

17. The robot of claim 16, wherein the bellows is an accordion-like bellows, having alternating ridges and valleys, made from an elastomeric polymer, and the cables are located at least partially inside the bellows.

18. The robot of claim 16, wherein the electric motors within the fin nodes reorient the fins to account for pipe obstructions or different internal diameters of the corrugated pipe to which tips of the fins contact during movement of the robot therethrough.

19. The robot of claim 16, wherein the programmable controller detects internal ridges of the corrugated pipe while the robot is moving therein, and the controller automatically determines a location of the robot within the corrugated pipe.

20. The robot of claim 16, wherein the programmable controller detects and counts contraction/expansion cycles of the robot while the robot is moving in the corrugated pipe, and the controller automatically determines a location of the robot within the corrugated pipe.

21. The robot of claim 16, wherein the programmable controller automatically creates a map of an underground network of the corrugated pipe by moving the robot therethrough while automatically tracking positions of the robot, without the use of GPS.

22. A robot comprising:
a first node;
a second node longitudinally spaced apart from the first node;
elastomeric bellows spanning between and pushing apart the nodes;
a first set of fins outwardly projecting from the first node;
a second set of fins outwardly projecting from the second node;
at least one longitudinally extending and flexible cable; and
at least one electric motor being configured to cause pulling and releasing of the at least one cable to contract the nodes toward each other.

23. The robot of claim 22, further comprising:
a first fin electric motor located within the first node operably moving the first set of fins when reverse direction movement of the robot is desired; and
a second fin electric motor located within the second node operably moving the second set of fins when the reverse direction movement of the robot is desired.

24. The robot of claim 22, wherein each of the fins includes at least one slit in an edge away from a longitudinal movement direction of the robot, which allows the fin to flex when a top of the fin passes over an internal ridge of a corrugated pipe.

25. The robot of claim 22, further comprising an elongated arm rotatable by the at least one electric motor, and movement of the arm operably causing pulling of the at least one cable.

26. The robot of claim 22, further comprising a third node including a programmable controller therein which is configured to automatically detect internal ridges of a corrugated pipe while the robot is moving therein, and the controller is configured to automatically determine a location of the robot within the corrugated pipe.

27. The robot of claim 22, further comprising a third node including a programmable controller therein which is configured to automatically detect and count contraction/expansion cycles of the robot while the robot is moving in a corrugated pipe, and the controller is configured to automatically determine a location of the robot within the corrugated pipe.

28. The robot of claim 22, wherein at least one of the fins includes a polymeric material and an electrically conductive material, and the electrically conductive material assisting with automatically determining at least one of: (a) position of the robot within a pipe, or (b) the presence of a liquid within the pipe.

29. The robot of claim 22, further comprising a camera moving with the robot, a programmable controller moving with the robot, and a battery moving with the robot, the battery supplying electricity to the camera and the controller, and the camera optically sensing corrugated ridges within a pipe while the robot moves therein and the controller automatically determining at least one of: (a) a position of the robot within the pipe, or (b) a distance traveled of the robot within the pipe, based at least in part from the sensed ridges from the camera.

30. A robot comprising:
a first node;
a second node longitudinally spaced apart from the first node;
a biasing body spanning between the nodes;
a first set of fins outwardly and oppositely projecting from the first node;
a second set of fins outwardly and oppositely projecting from the second node;
at least one longitudinally extending tendon being configured to contract the nodes toward each other; and
a third node including a programmable controller therein which is configured to automatically determine a location of the robot within a corrugated pipe by at least one of:
(a) automatically detecting internal ridges of the corrugated pipe while the robot is moving therein; or
(b) automatically detecting and counting contraction/expansion cycles of the robot while the robot is moving in the corrugated pipe.

31. The robot of claim 30, wherein the programmable controller automatically creates a map of an underground network of the corrugated pipe by moving the robot therethrough while automatically tracking positions of the robot, without the use of GPS.

32. The robot of claim 30, further comprising:
a first electric motor located within the first node operably moving the first set of fins when reverse direction movement of the robot is desired;
a second electric motor located within the second node operably moving the second set of fins when the reverse direction movement of the robot is desired;
at least a third electric motor pulling and releasing the tendon, which includes flexible cables; and
the programmable controller being configured to automatically energize the electric motors to:
(a) compress and expand the first and the second nodes in order to longitudinally move the robot along the corrugated pipe; and
(b) to automatically advance and reverse longitudinal movement direction of the robot within the corrugated pipe.
